(19) United States
(12) Patent Application Publication
(10) Pub. No.: US 2008/0018248 A1
(43) Pub. Date: Jan. 24, 2008

(54) Plasma display apparatus

(76) Inventors: Youn Jin Jung, Gumi-si (KR); Yun Gi Kim, Busan-si (KR)

Correspondence Address: KED & ASSOCIATES, LLP, P.O. Box 221200, Chantilly, VA, 20153-1200, US

(21) Appl. No.: 11/723,342

(22) Filed: Mar. 19, 2007

(30) Foreign Application Priority Data
May 22, 2006 (KR) 10-2006-0045728
May 22, 2006 (KR) 10-2006-0045729

(51) Int. Cl. H01J 17/16

(52) U.S. Cl. 313/582

(57) ABSTRACT

The plasma display apparatus includes a first electrode and a second electrode which include a transparent electrode and a bus electrode, and a black layer formed on the front substrate includes a first black layer formed on the position overlapped with the barrier rib, and a second black layer formed between the transparent electrode and the bus electrode. A contrast is improved by a separate type BM structure where the first black layer is separated from the second black layer, and the reactive current is reduced by lowering the panel capacitance. The light emission by a discharge is smoothly performed by controlling the width of the upper portion and the lower portion of the second barrier rib, and the width of the first barrier rib according to the width of the second barrier rib.

This application claims the benefit of Korean Patent Application No. 10-2006-0045728 filed on May 22, 2006, and Korean Patent Application No. 10-2006-0045729 filed on May 22, 2006, which is hereby incorporated by reference for all purposes as if fully set forth herein.

### BACKGROUND OF THE INVENTION

1. Field of the Invention

The present invention relates to a plasma display panel, more particularly, to an inter-electrode distance in the structure where a black layer and an electrode are separated from each other, and, to a width of a barrier rib in the structure where a black layer and an electrode are separated from each other.

2. Description of the Related Art

A plasma display panel hereinafter, PDP is an apparatus for displaying an image including a character and a graphic by performing a discharge through applying a predetermined voltage to electrodes arranged in a discharge space, and by exciting the phosphor with the plasma generated in the gaseous discharge time. The plasma display panel has an advantage in that a large size, a light weight and a plane thin shaping are facilitated, the wide viewing angle to the up down left right can be provided, and the full-color and the high luminance can be implemented.

The plasma display panel includes a front substrate and a rear substrate. On the front substrate, a transparent electrode and a plurality of sustain electrodes which are comprised of a bus electrode that is formed on the transparent electrode are disposed. On the rear substrate, a plurality of discharge spaces, that is, barrier ribs for forming a cell are disposed and a plurality third electrode intersecting with the sustain electrode are disposed.

The sustain electrode is classified into a bus electrode and a transparent electrode. As to the bus electrode, the inter-bus electrode distance in the cell is set to be a maximum. Thus, the bus electrode gets to be adjacent to the partition. At this time, the bus electrode and the barrier rib play a role of capacitor, while the panel capacitance increases due to the voltage accumulation. Moreover, there is a problem in that the consumption of the reactive current gets to increase due to the increment of the panel capacitance.

### SUMMARY

Accordingly, an object of the present invention is to solve at least the problems and disadvantages of the background art.

The object of the present invention is to separate a bus electrode and a black layer from each other, to set up the ratio of the distance between the electrodes for reducing the panel capacitance between a front substrate and a rear substrate, to set up the optimal width and the ratio of a barrie rib and the black layer.

A plasma display apparatus according to an aspect of the present invention includes a front substrate where a first electrode is formed in parallel with a second electrode; a rear substrate where a third electrode is formed to intersect with the first electrode and the second electrode; and a first barrier rib and a second barrir rib that form a discharge cell by intersecting with each other between the front substrate and the rear substrate, wherein the second barrir rib is formed in parallel with the first electrode and the second electrode, wherein each of the first electrode and the second electrode is separately disposed into the direction of the center of the discharge cell from the edge of the upper portion of the second barrir rib, while the longest distance between the first electrode and the second electrode ranges from 0.5 times to 1 times of the distance between the edges of the upper portion of the second barrir rib.

A plasma display apparatus according to another aspect of the present invention includes a front substrate where a first electrode is formed in parallel with a second electrode; a rear substrate where a third electrode is formed to intersect with the first electrode and the second electrode; and a first barrier rib and a second barrir rib that form a discharge cell by intersecting with each other between the front substrate and the rear substrate, wherein the second barrir rib is formed in parallel with the first electrode and the second electrode, wherein each of the first electrode and the second electrode is separately disposed into the direction of the center of the discharge cell from the edge of the upper portion of the second barrir rib, while the width of the upper portion of the second barrir rib ranges from 40 μm to 100 μm.

A plasma display apparatus according to further aspect of the present invention includes a front substrate where a first electrode is formed in parallel with a second electrode; a rear substrate where a third electrode is formed to intersect with the first electrode and the second electrode; and a first barrier rib and a second barrir rib that form a discharge cell by intersecting with each other between the front substrate and the rear substrate, wherein the second barrir rib is formed in parallel with the first electrode and the second electrode, wherein a black layer is formed on the second barrir rib, wherein each of the first electrode and the second electrode is separately disposed into the direction of the center of the discharge cell from the edge of the upper portion of the second barrir rib, while the width of the first black layer ranges from 0.8 times to 2.55 times of the width of the upper portion of the second barrir rib.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention. In the drawings:

FIG. 1 is a drawing illustrating an embodiment of the electrode arrangement of a plasma display apparatus.

FIG. 2 is a timing diagram illustrating an embodiment of the method of time divided driving by dividing one frame into a plurality of subfields.

FIG. 3 is a timing diagram illustrating an embodiment of the driving signals for driving a plasma display apparatus in one divided subfield.

FIG. 4 is a perspective view illustrating an embodiment of the structure of a plasma display apparatus according to the present invention.

FIG. 5a to FIG. 5b are a cross section view illustrating an embodiment of the structure of a panel including a separate type BM according to the present invention.

FIG. 6 is a cross section view of a panel according to the present invention.

FIG. 7a is a graph illustrating the change of the panel capacitance according to the rate of the distance between barrier ribs and the distance between electrodes.

FIG. 7b is a graph illustrating the change of the luminance according to the rate of the distance between barrier ribs and the distance between electrodes.

FIG. 8 is a drawing illustrating an embodiment of a panel in which a first barrier rib and a second barrier rib of a plasma display apparatus according to the present invention are formed.

FIG. 9a is a graph illustrating the change of the panel capacitance according to the width of the upper portion of the second barrier rib.

FIG. 9b is a graph illustrating the change of the luminance according to the width of the upper portion of the second barrier rib.

FIG. 10a, FIG. 10b are a drawing illustrating the cross section of a panel cut down in the direction intersecting with the sustain electrode according to an embodiment of the present invention.

FIG. 11a to FIG. 11c are a drawing illustrating the structure of a third electrode of a plasma display apparatus according to an embodiment of the present invention.

### DETAILED DESCRIPTION OF PREFERRED EMBODIMENTS

Reference will now be made in detail to embodiments of the present invention, examples of which are illustrated in the accompanying drawings.

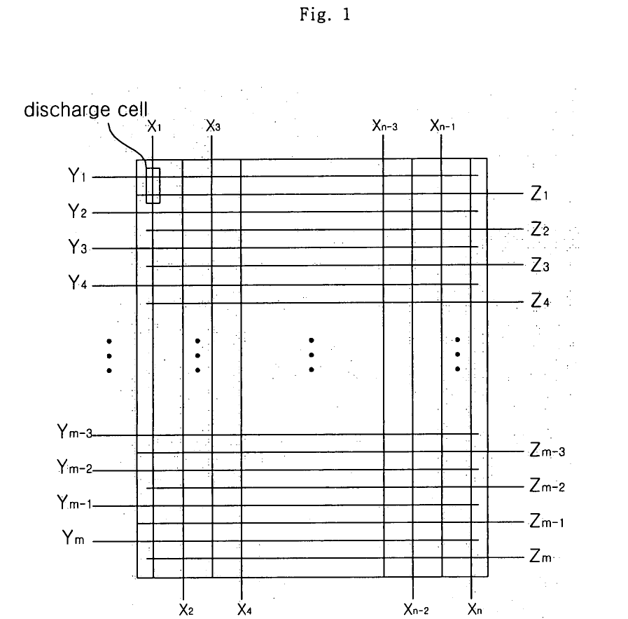

Hereinafter, the embodiment of the present invention will be described in detail with reference to FIG. 1 to FIG. 10b. FIG. 1 is a drawing illustrating an embodiment of the electrode arrangement of a plasma display apparatus. It is preferable that, as shown in FIG. 1, a plurality of discharge cells comprising the plasma display apparatus are arranged with a matrix type.

A plurality of discharge cells are prepared in the interperiod of a first electrode line Y1 to Ym, a second electrode line Z1 to Zm and a third electrode line X1 to Xn. The first electrode line Y1 to Ym can be sequentially drived or can be simultaneously drived, while the second electrode line Z1 to Zm can be simultaneously drived. The third electrode line X1 to Xn can be divided into even number lines and odd number lines to be drived or can be simultaneously drived.

In the above, the first electrode can be named a scan electrode, while the second electrode can be named a sustain electrode. The third electrode can be named an address electrode.

The electrode arrangement shown in FIG. 1 is just an embodiment of the electrode arrangement of a plasma apparatus according to the present invention. Therefore, the invention is not restricted to the driving method and the electrode arrangement of the plasma display panel shown in FIG. 1. For example, a dual scan mode where two first electrode lines among the first electrode lines Y1 to Ym are simultaneously scanned can be available. Further, in the center area of the panel, the third electrode line X1 to Xn can be divided into an upper portion and a lower portion to be drived. At this time, it is preferable that the distance between the third electrodes which are divided into the upper portion and the lower portion is formed within the range of 70 to 200 μm so as to prevent the problem that a minute step height is generated in a screen due to the separation of the electrode line into the upper portion and the lower portion.

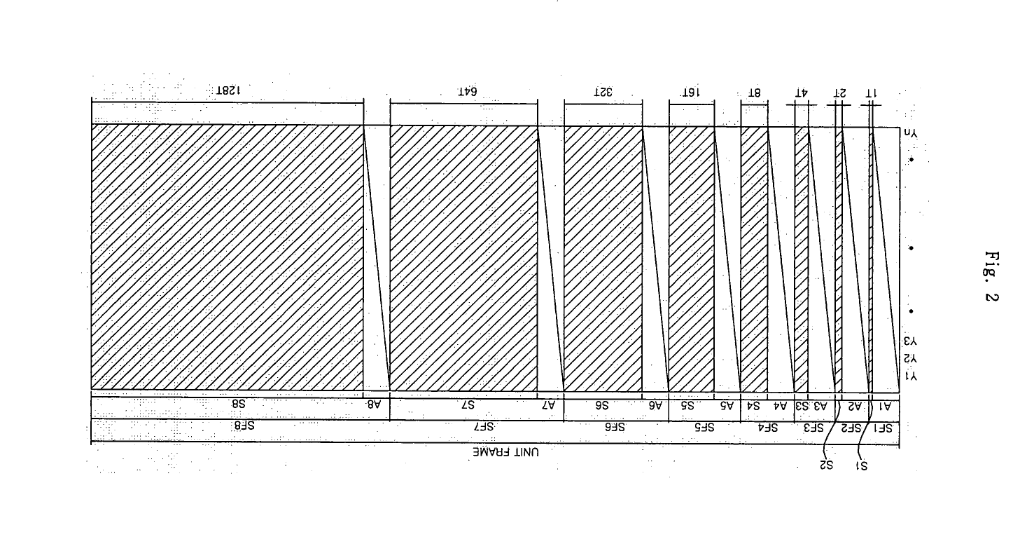

FIG. 2 is a timing diagram illustrating an embodiment of the method of time divided driving by dividing one frame into a plurality of subfields. Referring to FIG. 2, the unit frame can be divided into a predetermined number, for example, 8 subfields SF1, . . . , SF8 so as to implement a time divided grayscale. Further, each subfield SF1, . . . , SF8 is divided into a reset period not shown, an address period A1, . . . , A8, and a sustain period S1, . . . , S8.

Here, according to the embodiment of the present invention, the reset period can be omitted in at least one subfield among a plurality of subfields. For example, the reset period can exist only in the first subfield, or exist in the intermediate subfield between the first and the total subfield.

In each address period A1, . . . , A8, an address signal is applied to the third electrode X, while the scan signal corresponding to each first electrode Y is sequentially applied to one or two first electrode lines.

In each sustain period S1, . . . , S8, a sustain signal is alternately applied to the first electrode Y and the second electrode Z such that a sustain discharge is generated in discharge cells in which wall charges are formed in the address period A1, . . . , A8. Further, according to the embodiment of the present invention, at least one among a plurality of sustain periods can be omitted, and the sustain signal can be applied to only one of the first electrode Y and the second electrode Z. In this way, in case the sustain period is omitted or the sustain signal is applied to only one electrode, the grayscale can be increased. It is preferable that such implementation is applied to the first sustain address S1 to the third sustain address S3.

The luminance of the plasma display panel is in proportion to the number of the sustain discharge pulse in the sustain discharge period S1, . . . , S8 of an unit frame. In case one frame forming one image is expressed with 8 subfields and 256 gray scales, the sustain signal having different number can be allocated to each subfield in the rate of 1, 2, 4, 8, 16, 32, 64, 128. To obtain the luminance of 133 gray scale, cells are addressed during subfield 1 period, subfield 3 period and subfield 8 period to perform a sustain discharge.

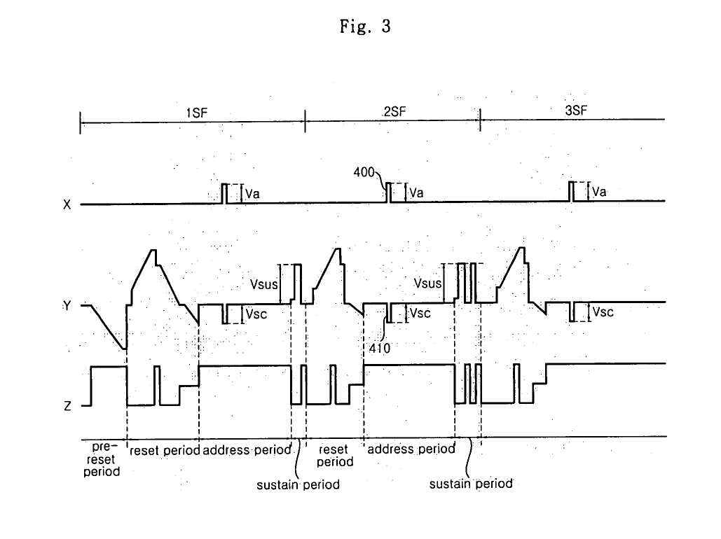

According to the weighted value of the subfields depending on APC Automatic Power Control step, the sustain discharge number allocated to each subfield can be variably determined. That is, in FIG. 3, it is exemplified that one frame is divided into 8 subfields. However, the invention is not restricted to such case, but the number of the subfield forming one frame can be variously changed according to a design type. For example, a frame can be divided into 8 subfield or more like 12 subfield or 16 subfield to drive the plasma display panel.

FIG. 3 is a timing diagram illustrating an embodiment of the driving signals for driving a plasma display apparatus in one divided subfield.

The subfield includes a pre reset period for forming positive wall charges on the first electrodes Y and negative wall charges on the second electrodes Z, a reset period for initializing the discharge cells of the full screen by using the wall charge distribution formed by the pre reset period, an address period for selecting the discharge cell and a sustain period for maintaining the discharge of the selected discharge cells.

The reset period is comprised of a setup period and a setdown period. In the setup period, a ramp-up waveform is simultaneously applied to all first electrodes to generate a microdischarge in all discharge cells. Accordingly, wall charges are generated. In the set down period, a ramp-down waveform falling from the positive polarity voltage lower than the peak voltage of the ramp-up waveform is applied to all first electrodes Y to generate an erase discharge in all discharge cells. Accordingly, the wall charges generated by the setup discharge and an unnecessary charge among space discharges are erased.

Further, according to the embodiment of the present invention, the set up period in which the ramp-up waveform is applied is omitted in at least one subfield among a plurality of subfield such that the set down period in which the ramp-down waveform is applied can only exist. In this way, although the set up period is omitted and the set down period only exist in at least one subfield, the initialization of the discharge cell is possible. In addition, the driving time margin increases such that it is advantageous for driving, especially, for single scan driving.

In the address period, the scan signal 410 that has scan voltage Vsc of negative polarity is sequentially applied to the first electrode, while the address signal 400 that has address voltage Va of positive polarity is applied to the third electrode X so as to be overlapped with the scan signal. The address discharge is generated due to the width of the voltage of the scan signal 410 and the address signal 400 and the wall voltage generated during the reset period, thereby, a cell is selected. In the meantime, during the set down period and the address period, a signal maintaining the sustain voltage is applied to the second electrode.

In the sustain period, the sustain signal is alternately applied to the first electrode and the second electrode and the sustain discharge is generated between the first electrode and the second between electrode as a surface discharge.

The drive waveforms shown in FIG. 3 are a first embodiment of the signals for driving a plasma display apparatus according to the present invention. The invention is not restricted by waveforms shown in FIG. 3. For example, the pre reset period can be omitted and the polarity and the voltage level of the driving signals shown in FIG. 3 can be changed, if necessary. Further, the erase signal for erasing the wall charge can be applied to the second electrode after the sustain discharge is completed.

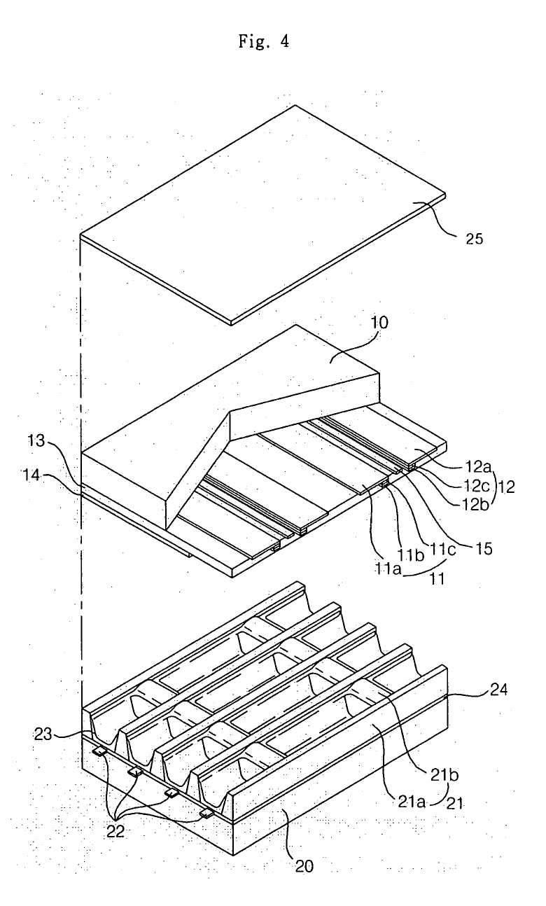

Moreover, the single sustain drive mode in which the sustain signal is applied to only one of the first electrode Y and the sustain electrode Z to generate the sustain discharge. The panel to which such drive waveform is supplied is formed as shown in FIG. 4.

FIG. 4 is a perspective view illustrating an embodiment of the structure of a plasma display apparatus according to the present invention.

As shown in FIG. 4, the plasma display apparatus includes a first electrode 11 and a second electrode 12 which are a sustain electrode pair formed in the front substrate 10 and a third electrode 22 formed in the rear substrate 20.

Generally, the sustain electrode pair 11, 12 includes a transparent electrode 11a, 12a formed of Indium-Tin-Oxide ITO and a bus electrode 11b, 12b. The bus electrode 11b, 12b can be formed of the stack of metal such as silver Ag, chrome Cr or chrome/copper/chrome Cr/Cu/Cr or the stack of chrome/aluminium/chrome Cr/Al/Cr. Bus electrode 11b, 12b is formed on the transparent electrode 11a, 12a and plays a role of reducing the voltage drop by the transparent electrode 11a, 12a having a high resistance. At this time, during the first electrode discharge and the second electrode discharge, it is preferable that the distance between the transparent electrodes 11a, 12a for maximizing the discharge efficiency ranges from 90 μm to 150 μm.

In the meantime, according to the embodiment of the present invention, the sustain electrode pair 11, 12 can be comprised of only the bus electrode 11b, 12b without the transparent electrode 11a, 12a as well as the structure in which the transparent electrode 11a, 12a and the bus electrode 11b, 12b are laminated. Such structure has an advantage in that the cost of the panel manufacture can be reduced since the transparent electrode 11a, 12a is not used. Various materials including a photoresist material are available for the bus electrode 11b, 12b used for such structure except the materials mentioned above.

According to the embodiment of the present invention, the black layer which absorbs the external light to reduce a reflection and improves a contrast is formed on the front substrate 10. It can be comprised of a first black layer 15 which is formed in the position overlapped with the barrier rib 21, and a second black layers 11c, 12c formed between the transparent electrode 11a, 12a and the bus electrode 11b, 12b. Here, the first black layer 15 and the second black layers 11c, 12c are separated so as not to be physically connected. In this case, the first black layer 15 and the second black layers 11c, 12c can be formed with a different material. On the front substrate 10 in which the first electrode 11 and the second electrode 12 are formed side by side, a front dielectric layer 13 and a protective layer 14 are laminated. On the front dielectric layer 13, charged particles generated by a discharge are accumulated. The front dielectric layer 13 can play a role of protecting a sustain electrode pair 11, 12. The protective layer 14 protects the front dielectric layer 13 from the sputtering of the charged particles generated during the gaseous discharge, emitting the secondary electron to enhance the discharge efficiency.

Further, the third electrode 22 is formed in the direction intersecting with the first electrode 11 and the second electrode 12. On the rear substrate 20 in which the third electrode 22 is formed, a rear dielectric layer 24 and a barrier rib 21 are formed. A phosphor layer 23 is formed on the surface of the barrier rib 21 and the rear dielectric layer 24.

The barrier rib 21 including a first barrier rib 21a and a second barrier rib 21b physically partitions the discharge cell. The second barrier rib 21b is formed in the direction where the sustain electrode 11, 12 of the front substrate 10 extends, while the first barrier rib 21a is formed into the direction different from the direction of the second barrier rib 21b to intersect with the second barrier rib 21b.

Referring to FIG. 4, it is preferable that a filter 25 is formed on the front of the plasma display panel according to the embodiment of the present invention, while an external light blocking layer, an Anti-Reflection AR layer, an Near Infrared NIR shielding layer or an ElectroMagnetic Interference EMI shielding layer can be included in the filter 25.

In the embodiment of the present invention, the structure of the barrier rib 21 having various shapes as well as the structure of the barrier rib 21 shown in FIG. 4 can be available. For example, a differential type barrier rib structure where the height of the first barrier rib 21a is different from the second barrier rib 21b, a channel type barrier rib structure where a channel which can be used as a ventilating passage is formed in at least one of the first barrier rib 21a and the second barrier rib 21b, and a groove type barrier rib structure where hollows are built up in at least one of the first barrier rib 21a and the second barrier rib 21b can be used.

Here, in case of the differential type barrier rib structure, it is preferable that the height of the first barrier rib 21a is higher than the second barrier rib 21b, while, in case of the channel type barrier rib structure or the groove type barrier rib structure, it is preferable that a channel or a hollow is formed in the second barrier rib 21b.

In the meantime, in the embodiment of the present invention, it is illustrated that R, G and B discharge cells are arranged in the identical line. However, other arrangements can be used. For example, the arrangement of a delta type where R, G, and B discharge cells are arranged in a triangle form can be used. Further, as to the shape of the discharge cell, various polygonal shapes including the pentagon, the hexagon as well as the square shape can be used.

The phosphor layer 23 is light-emitted by the ultraviolet ray generated during the gaseous discharge to generate a visible light which is one of Red R, Green G, and Blue B. Here, an inert mixing gas for a discharge including He+Xe, Ne+Xe and He+Ne+Xe is injected into the discharge space prepared in the front/rear substrate 10, 20 and the barrier rib 21.

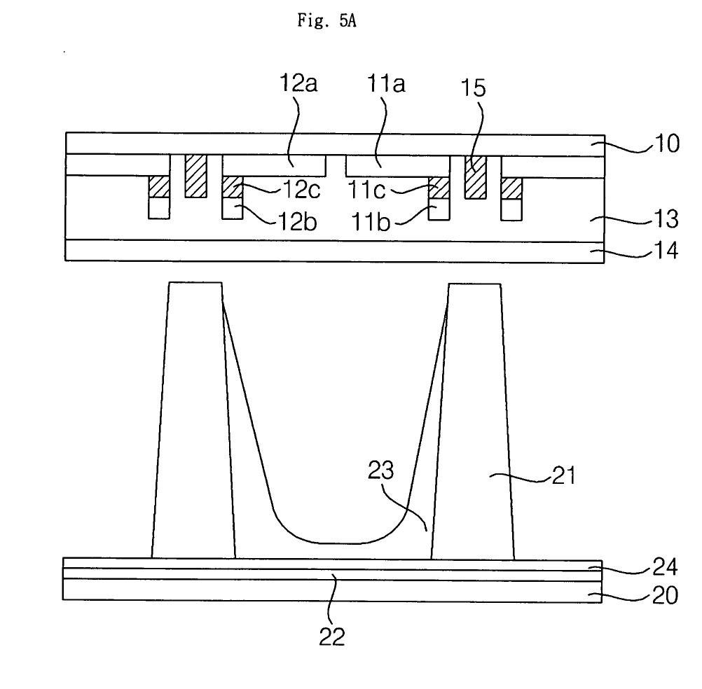

As to the plasma display apparatus having such structure, the black layer illustrated in FIG. 4 will be described in detail with reference to FIG. 5A and FIG. 5B.

FIG. 5a to FIG. 5b are a cross section view illustrating an embodiment of the structure of a panel including a separate type BM according to the present invention.

As to the separate type BM, the light generated by the discharge can be radiated between the first, the second black layer 15, 11c, 12c to the outside of the panel to increase a luminance. At this time, the luminance of the panel is increased as the light generated in the discharge cell is more emitted to the outside, while the distance between electrodes in the discharge cell is in proportion to the quantity of the light emission. In this way, the luminance of the panel is increased as the distance between the electrodes is increased.

Here, the width of the first black layer 15 can be formed broader than the width of the second black layer 11c, 12c.

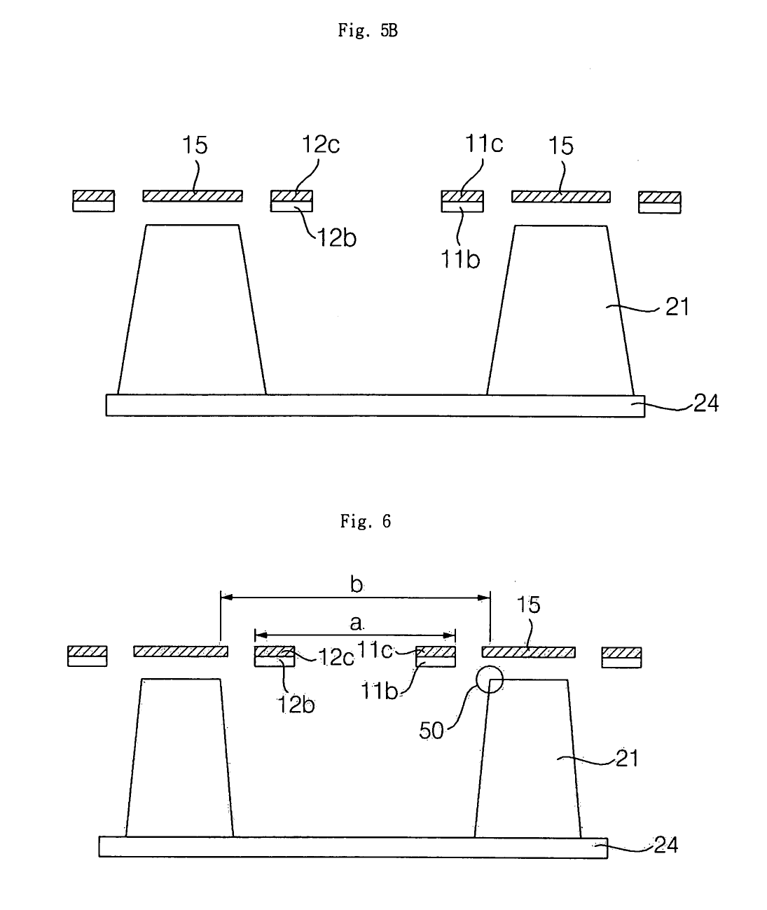

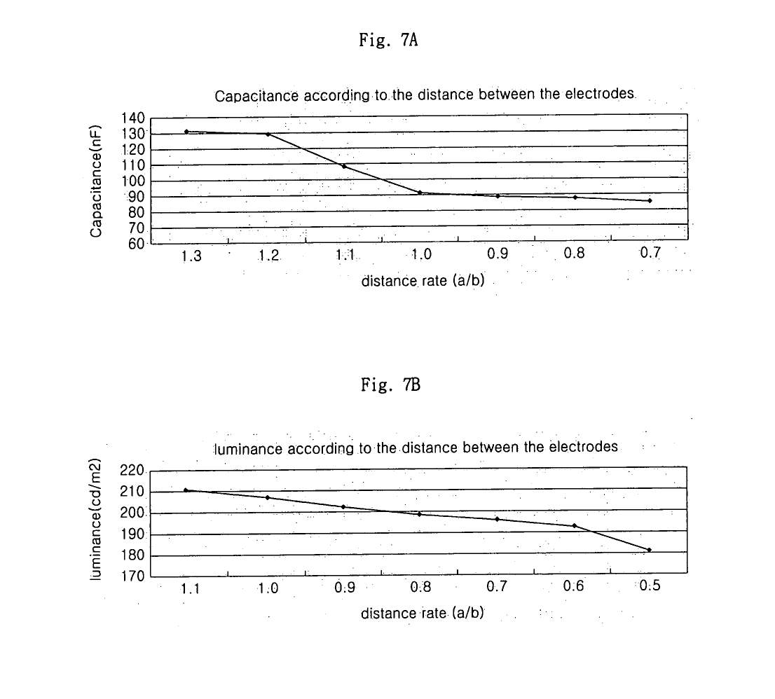

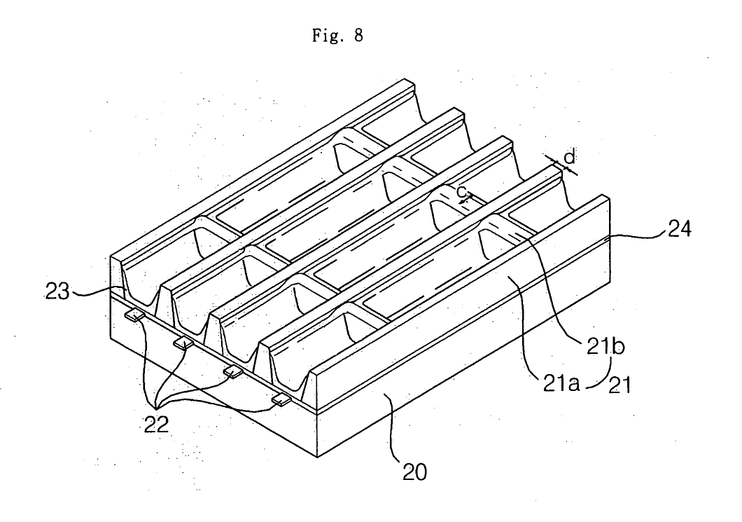

In the embodiment of the present invention, since the bus electrode 11b, 12b is positioned in the discharge space, the panel capacitance between the bus electrode 11b, 12b and the barrier rib 21 is reduced. That is, the barrier rib 21 and the bus electrodes 11b, 12b play a role of a capacitor to generate a panel capacitance. In case the bus electrode 11b, 12b is positioned in the region overlapped with the barrier rib 21, the panel capacitance is increased. That is, as the region where the bus electrode 11b, 12b is overlapped with the second barrier rib 21b is increased, the panel capacitance tends to increase. As the panel capacitance is increased, the consumption of the reactive power in the panel is increased such that the efficiency of the panel is decreased. Therefore, in the embodiment of the present invention, the relation between the second barrier rib 21b and the bus electrode 11b, 12b will be described with reference to FIG. 6, FIG. 7a and FIG. 7b to reduce the consumption of the reactive power and to improve the efficiency of the panel.

FIG. 6 is a cross section view of a panel according to the present invention.

In FIG. 6, the reference sign ‘a’ denotes the longest distance between the bus electrodes 11b, 12b which are adjacent in the discharge cell, while the reference sign ‘b’ denotes the distance between the upper corners 50 of the inner side of two second barrier ribs 21b.

At this time, the upper corner 50 of the inner side of the second barrier rib 21b is determined as the most close area to outer side of the bus electrode 11b, 12b in the most upper portion of the inner side of the second barrier rib 21b. That is, according to the embodiment of the present invention, the bus electrode 11b, 12b is positioned in the inside of the discharge space between the second barrier ribs 21b, while it is not overlapped with the upper corner 50 of the inner side of the second barrier rib 21b. Therefore, according to the embodiment of the present invention, the bus electrode 11b, 12b can be overlapped with the other region except the upper corner 50 of the inner side of the second barrier rib 21b, for example, the bottom portion or the middle portion of the second barrier rib 21b.

At this time, as described above, the upper corner 50 of the inner side of the second barrier rib 21b was determined as the most close area to the outer side of the bus electrode 11b, 12b, since the present invention controls the gap between the bus electrode 11b, 12b and the second barrier rib 21b to reduce the panel capacitance.

In the meantime, not shown in FIG. 6, at least a part of or the whole of the transparent electrode 11a, 12a is positioned in the inside of the discharge cell and can be overlapped with the first black layer 11c, 12c.

FIG. 7a is a graph illustrating the change of the panel capacitance according to the rate of the distance between barrier ribs and the distance between electrodes, and FIG. 7b is a graph illustrating the change of the luminance according to the rate of the distance between barrier ribs and the distance between electrodes.

As shown in FIG. 7a, as to the panel capacitance, the rate a/b which is the distance of the bus electrodes 11b, 12b for the distance of the second barrier rib 21b abruptly decreases between 1.0 and 0.8. Further, as shown in FIG. 7b, the luminance is increased as the rate of the distance of the bus electrodes 11b, 12b for the distance of the second barrier rib 21b increases, while it rapidly increases when the rate a/b is 0.5 or more.

In this way, through the graph for the panel capacitance and luminance, if the rate of the distance of the bus electrodes 11b, 12b for the distance of the second barrier rib 21b is 0.5<a/b<1, the luminance is not so much reduced, while the panel capacitance so much reduced, thereby, the efficiency of the panel is improved. According to the embodiment of the present invention, preferably, it is illustrated that the efficiency of the panel is more improved in case the value a/b ranges from 0.6 to 0.8 with reference to FIG. 7a, FIG. 7b.

FIG. 8 is a drawing illustrating an embodiment of a panel in which a first barrier rib and a second barrier rib of a plasma display apparatus according to the present invention are formed.

As shown in FIG. 8, the discharge cell is surrounded with the second barrier rib 21b and the first barrier rib 21a. The width of the upper portion of the barrier rib 21 means the width c of the upper portion of the second barrier rib 21b and the width d of the upper portion of the first barrier 21a.

At this time, a proper value of the width c of the upper portion of the second barrier rib 21b for improving the efficiency of the discharge of the adjacent cells and reducing the interference is suggested.

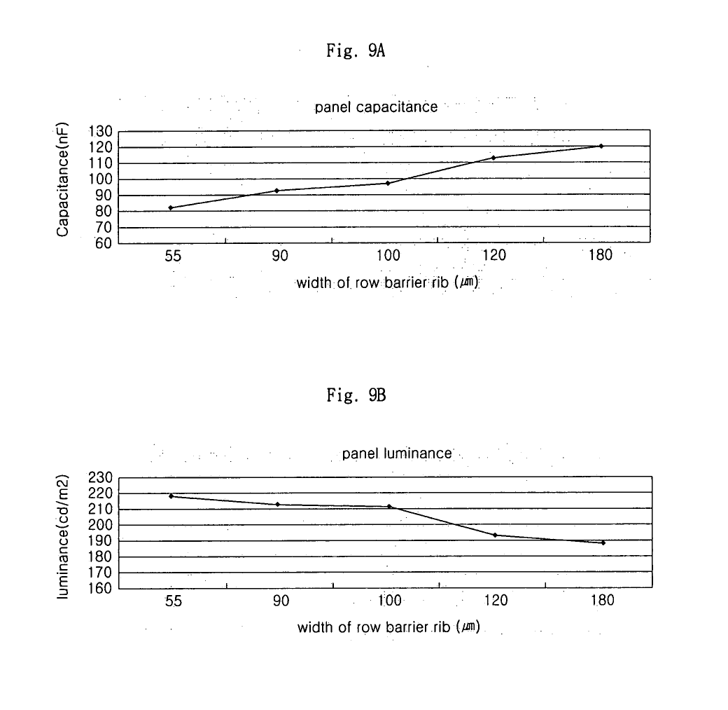

FIG. 9a is a graph illustrating the change of the panel capacitance according to the width of the upper portion of the second barrier rib, and FIG. 9b is a graph illustrating the change of the luminance according to the width of the upper portion of the second barrier rib.

As shown in FIG. 9a, as to the panel capacitance, it rapidly increases when the width c of the upper portion of the second barrier rib 21b is 100 μm or more, while it decreases when the width c of the upper portion of the second barrier rib 21b is 100 μm or less. Further, as shown in FIG. 9b, as to the luminance, it rapidly increases when the width c of the upper portion of the second barrier rib 21b is 120 μm or less while it is stable below 100 μm.

At this time, it can be known that the panel capacitance reduces as the width c of the upper portion of the second barrier rib 21b becomes narrower. However, there is a problem in that in case the width c of the upper portion of the second barrier rib 21b is smaller than 40 μm, the manufacture of the second barrier rib 21b becomes very difficult in the process, and the alignment of the sustain electrode pair also becomes difficult.

That is, in the embodiment of the present invention, the optimal range of the width c of the upper portion of the second barrier rib 21b where the panel capacitance reduces and the luminance is increased is limited to 40 μm≦c≦100 μm, however, afterwards, the width c of the upper portion of the second barrier rib 21b can be smaller than 40 μm or less according to the manufacturing technology of the barrier rib. That is, in the embodiment of the present invention, considering the tolerance or the yield of the panel manufacturing, the width c of the upper portion of the second barrier rib 21b was set to be 40 μm or more. However, in case the process improvement in the future is considered, the width c can not be limited to 40 μm, but can be 40 μm or less. In the meantime, considering the yield of the panel manufacturing or the reliability of the tolerance, it is more preferable that the width c of the upper portion of the second barrier rib 21b according to the embodiment of the present invention ranges from 55 μm to 100 μm.

Furthermore, preferably, the width d of the upper portion of the first barrier rib 21a is formed to be broader than the width c of the upper portion of the second barrier rib 21b, while the rate of the width d of the upper portion of the first barrier rib 21a and the width c of the upper portion of the second barrier rib 21b is 1:1 or 1:1.9. At this time, approximately, the optimal rate of the width d of the upper portion of the first barrier rib 21a and the width c of the upper portion of the second barrier rib 21b is 1:1. That is, also, as the width of the upper portion of the first barrier rib 21a decreases, the panel capacitance decrease, thereby, the panel efficiency is increased. As mentioned above, considering the manufacturing yield of the panel or the reliability of the tolerance, the minimum value of the width of the upper portion of the first barrier rib 21a can be reduced to the minimum value of the width c of the upper portion of the second barrier rib 21b. Furthermore, since the sustain electrode pair and the first black layer are formed on the front substrate overlapped with the upper portion of the second barrier rib 21b, it is preferable that the width c of the upper portion of the second barrier rib 21b is larger than the width d of the upper portion of the first barrier rib 21a, while it is 1.9 times or less than the width d of the upper portion of the first barrier rib 21a for the implementation of the super fine screen including Full HD.

The panel capacitance is generated between the barrier rib 21 and the bus electrode 11b, 12b. At this time, the value of the generated panel capacitance is changed depending on the distance between the second barrier rib 21b formed into the direction identical with the first direction in which bus electrode 11b, 12b is formed and the bus electrode 11b, 12b.

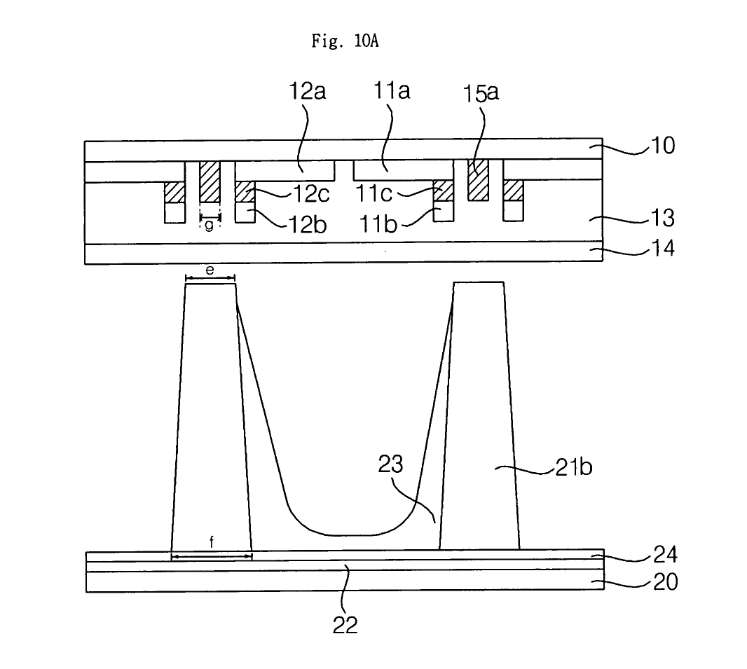

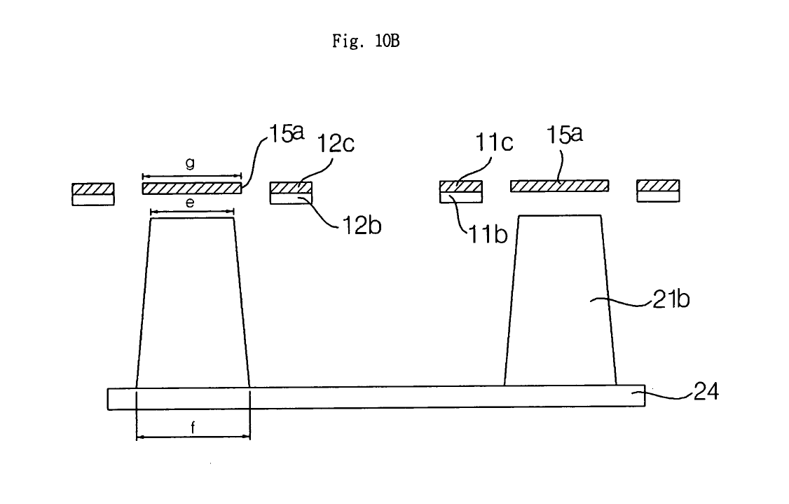

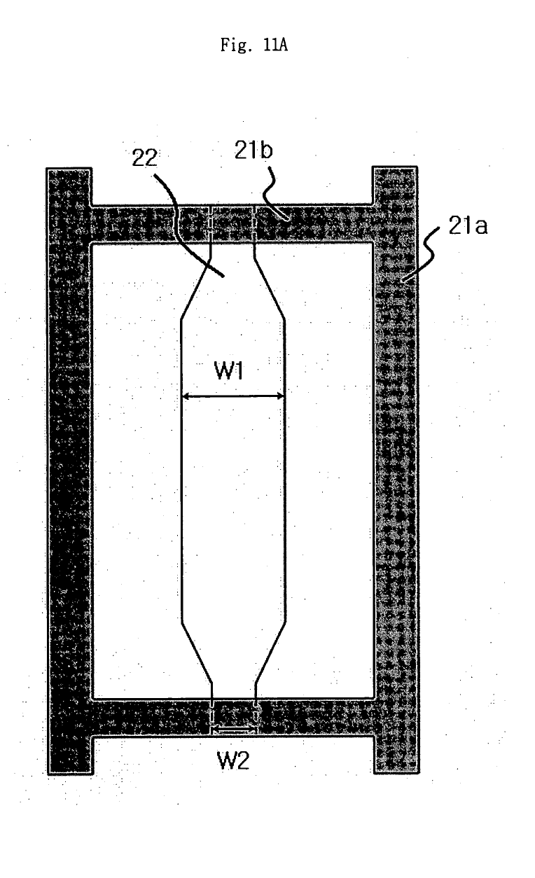

FIG. 10a, FIG. 10b are a drawing illustrating the cross section of a panel cut down in the direction intersecting with the sustain electrode according to an embodiment of the present invention.

As shown in FIG. 10a, FIG. 10b, it is preferable that, as to the second barrier rib 21b, the rate of the width e of the upper portion of the second barrier rib and the width f of the lower portion of the second barrier rib is 1:1 to 1:3 for increasing the discharge efficiency during the discharge within the cell. At this time, the width of the lower portion refers to the width of the part contacting with the rear dielectric layer 24.

The second barrier rib 21b and the first barrier 21a are formed with an optimal ratio such that the panel capacitance due to the area of the second barrier rib 21b can be reduced.

In the meantime, according to the embodiment of the present invention, the width g of the first black layer 15a illustrated in FIG. 4 to FIG. 5 ranges from 80 μm to 140 μm. It is seen that, in case the width g is compared with the width e of the upper portion of the second barrier rib 21b, the rate of the width e of the upper portion of the second barrier rib 21b and the width of the first black layer 15a is 1:1.08 to 1:2.5. That is, the first black layer 15a is formed on the upper substrate of the region overlapped with the second barrier rib 21b to prevent the light generated in the discharge cell from being emitted to the front substrate of the region overlapped with the second barrier rib 21b, thereby, it contributes to implement the clear picture quality. Therefore, in general, the first black layer 15a is not formed inside of the discharge cell so as not to affect the light emitted from the inside of the discharge cell. However, the quantity of the light emitted from the edge area, not from the central area, is very small in comparison with the quantity of the light emitted from the central area of the discharge cell. Thus, according to the embodiment of the present invention, the first black layer 15a is formed on the upper substrate of the position overlapped with the edge area of the discharge cell such that the reduction of the luminance can be decreased and the bright room contrast can be improved.

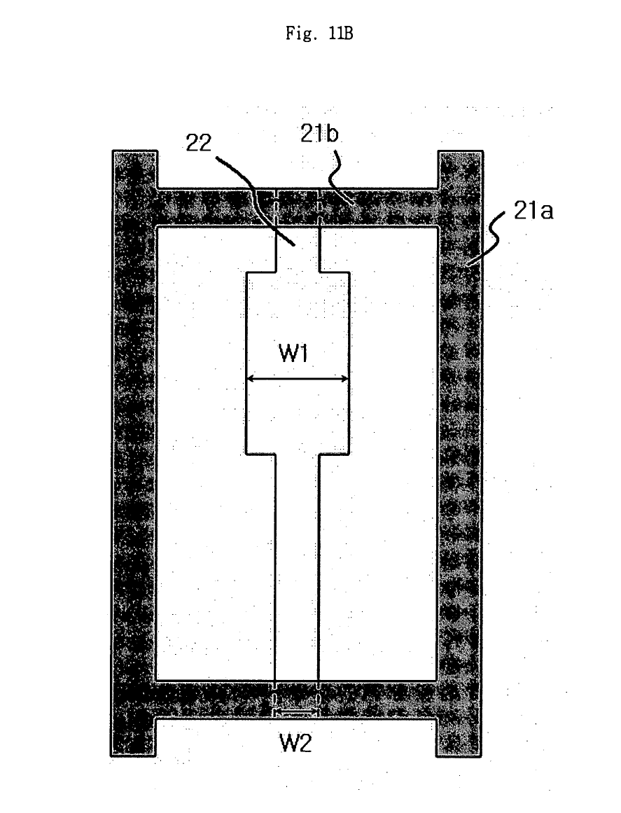

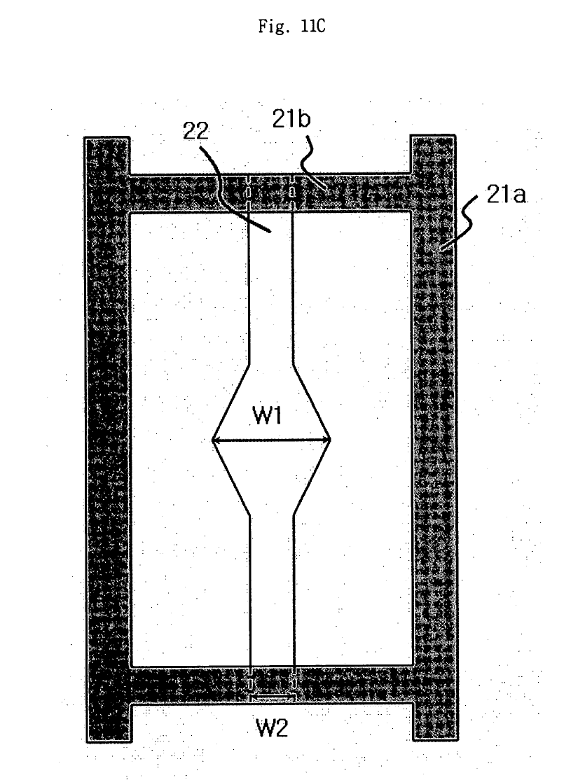

FIG. 11a to FIG. 11c are a drawing illustrating the structure of a third electrode of a plasma display apparatus according to an embodiment of the present invention.

Referring to FIG. 11a, the discharge cell is partitioned by the first barrier rib 21a and the second barrier rib 21b.

Here, the width of the third electrode 22 can be varied according to the position. For example, the width W1 of the third electrode 22 in the first position corresponding to the inside of the discharge cell can be different from a barrier rib, that is, the width W2 of the third electrode 22 in the second position corresponding to the second barrier rib 21b. For example, the width W1 of the third electrode 22 in the first position can be formed to be broader than the width W2 of the third electrode 22 on the second position such that the discharge characteristic can be improved.

That is, the region where the first electrode or the second electrode is overlapped with the third electrode 22 can be broadened such that the opposing discharge can be more accurately generated.

In this way, when the width W1 of the third electrode 22 in the first position corresponding to the inside of the discharge cell is formed to be broader than the width W2 of the third electrode 22 in the second position corresponding to the second barrier rib 21b, the width W1 of the third electrode 22 in the first position corresponding to the inside of the discharge cell becomes gradually narrow in the boundary of the discharge cell and fixed with the width W2 of the third electrode 22 in the second position.

As described in the above, by changing the width of the third electrode, the time from the application of the scan voltage to the generation of the discharge in the address period can be reduced such that the jitter character is improved to improve the discharge efficiency.

In this way, in the embodiment of the present invention, the region where the first electrode or the second electrode and the third electrode 22 are overlapped can be broadened to generate the opposing discharge well. As shown in FIG. 11a, in the whole region overlapped with the first electrode and the second electrode, the width W1 of the third electrode can be broader than the width W2 of the outside of the discharge cell overlapped with the barrier rib.

As to another embodiment, as shown in FIG. 11b, the width W1 of the third electrode can be formed to be broader in the region where one of the first electrode and the second electrode and the third electrode are overlapped.

As to still another embodiment, as shown in FIG. 11c, the width of the third electrode 22 in the central part of the discharge cell becomes gradually broader such that the lozenge can be formed.

Embodiments of the present invention described above are combined with various forms to be implemented.

As described in the above, the plasma display apparatus according to the present invention has the effect that a contrast is improved, and the reactive current is reduced by increasing a luminance and lowering the panel capacitance. Further, it has the effect that the emission of the light by a discharge is smoothly performed such that a luminance can be increased and the interference of the adjacent cells can be minimized, and it has the effect that the panel capacitance generated by a barrier rib is lowered such that the reactive current is reduced. Thereby, it has the effect that the sustain period where an image is displayed can be secured relatively longer since the address time during which the scan pulse is applied is reduced, and it has the effect that the discharge efficiency can be improved by improving the jitter characteristic when the width of the third electrode is variously changed.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display apparatus comprising:
a front substrate where a first electrode is formed in parallel with a second electrode;
a rear substrate where a third electrode is formed to intersect with the first electrode and the second electrode; and
a first barrier rib and a second barrir rib that form a discharge cell by intersecting with each other between the front substrate and the rear substrate,
wherein the second barrir rib is formed in parallel with the first electrode and the second electrode,
wherein each of the first electrode and the second electrode is separately disposed into the direction of the center of the discharge cell from the edge of the upper portion of the second barrir rib, and a longest distance between the first electrode and the second electrode ranges from 0.5 times to 1 times of a distance between the edges of the upper portions of the adjacent second barrir ribs.

2. The plasma display apparatus of claim 1, wherein the longest distance between the first electrode and the second electrode ranges from 0.5 times to 0.8 times of the distance between the edges of the upper portions of the adjacent second barrir ribs.

3. The plasma display apparatus of claim 1, further comprising;
a first black layer which is formed in the position corresponding to the second barrier rib on the front substrate,
wherein the first black layer is separated from the first electrode and the second electrode.

4. The plasma display apparatus of claim 3, wherein the first electrode and the second electrode include a transparent electrode and a bus electrode respectively, and a second black layer is formed between the transparent electrode and the bus electrode.

5. The plasma display apparatus of claim 4, wherein the width of the first black layer is greater than the width of the second black layer.

6. The plasma display apparatus of claim 1, wherein the first electrode and the second electrode are comprised of a bus electrode.

7. The plasma display apparatus of claim 1, wherein the width of the third electrode is greater in the inside of the discharge cell than in the outside of the discharge cell.

8. The plasma display apparatus of claim 1, wherein the width of the third electrode formed inside of the discharge cell is different in the discharge cell radiating a different color.

9. The plasma display apparatus of claim 1, wherein at least one of the first electrode and the second electrode is formed in the position overlapped with the part except the edge of the upper portion of the second barrier rib.

10. The plasma display apparatus of claim 1, wherein the height of the first barrier is greater than the height of the second barrier rib.

11. A plasma display apparatus comprising:
a front substrate where a first electrode is formed in parallel with a second electrode;
a rear substrate where a third electrode is formed to intersect with the first electrode and the second electrode; and
a first barrier rib and a second barrir rib form a discharge cell by intersecting with each other between the front substrate and the rear substrate,
wherein the second barrir rib is formed in parallel with the first electrode and the second electrode,
wherein each of the first electrode and the second electrode is separately disposed into the direction of the center of the discharge cell from the edge of the upper portion of the second barrir rib, and the width of the upper portion of the second barrir rib ranges from 40 μm to 100 μm.

12. The plasma display apparatus of claim 11, further comprising a first black layer which is formed in the position corresponding to the second barrier rib on the front substrate,
wherein the first black layer is separated from the first electrode and the second electrode.

13. The plasma display apparatus of claim 12, wherein the first electrode and the second electrode include a transparent electrode and a bus electrode respectively, and a second black layer is formed between the transparent electrode and the bus electrode.

14. The plasma display apparatus of claim 11, wherein the first electrode and the second electrode are comprised of a bus electrode.

15. The plasma display apparatus of claim 11, wherein the width of the lower portion of the second barrier rib ranges from 1 times to 3 times of the width of the upper portion of the second barrier rib.

16. A plasma display apparatus comprising:
a front substrate where a first electrode is formed in parallel with a second electrode;
a rear substrate where a third electrode is formed to intersect with the first electrode and the second electrode; and
a first barrier rib and a second barrir rib form a discharge cell by intersecting with each other between the front substrate and the rear substrate,
wherein the second barrir rib is formed in parallel with the first electrode and the second electrode,
wherein a black layer is formed on the second barrir rib,
wherein each of the first electrode and the second electrode is separately disposed into the direction of the center of the discharge cell from the edge of the upper portion of the second barrir rib, and the width of the first black layer ranges from 0.8 times to 2.55 times of the width of the upper portion of the second barrir rib.

17. The plasma display apparatus of claim 16, wherein the first black layer is separated from the first electrode and the second electrode.

18. The plasma display apparatus of claim 16, wherein the first electrode and the second electrode include a transparent electrode and a bus electrode respectively, and a second black layer is formed between the transparent electrode and the bus electrode.

19. The plasma display apparatus of claim 16, wherein the first electrode and the second electrode are comprised of a bus electrode.

20. The plasma display apparatus of claim 16, wherein the width of the lower portion of the second barrier rib ranges from 1 times to 3 times of the width of the upper portion of the second barrier rib.
